(19) United States
(12) Patent Application Publication
(10) Pub. No.: US 2024/0193655 A1
(43) Pub. Date: Jun. 13, 2024

(54) CENTRALIZED MARKETPLACE PLATFORM FOR TELECOMMUNICATIONS RELATED SERVICES

(71) Applicant: RAKUTEN MOBILE, INC., Tokyo (JP)

(72) Inventors: Gagandeep BASI, Tokyo (JP); Jun Liang LIM, Singapore (SG); Kumeresh KHANNA, Singapore (SG)

(73) Assignee: RAKUTEN MOBILE, INC., Tokyo (JP)

(21) Appl. No.: 17/908,119

(22) PCT Filed: May 13, 2022
(86) PCT No.: PCT/US2022/029140

§ 371 Date: Aug. 30, 2022

(51) Int. Cl. G06Q 30/0601; G06Q 30/0241

(52) U.S. Cl. CPC G06Q 30/0613; G06Q 30/0276; G06Q 30/0621

(57) ABSTRACT

A method, system, apparatus, and computer-readable medium for trading telecommunications related services on a centralized marketplace network. The method includes presenting a first telecommunications related service to a first user, wherein the first telecommunications related service is based on a configuration profile defined by a second user. The method further includes receiving a selection for the first telecommunications related service by the first user, and receiving a purchase order request from the first user with respect to the selected first telecommunications related service. The method may also include receiving input from the first user with respect to customizing or configuring the first telecommunications related service, receiving input from the first user to add the customized or configured first telecommunications related service to the purchase order request, and applying a price modification or reduction to the first telecommunications related service or the purchase order request.

### BACKGROUND

The traditional market for network related services is highly fragmented. Even in the age of the Internet, a buyer of network services typically has to contact each vendor individually through email or telephone, evaluate their qualifications and negotiate specifications and products, availability and price on an individual basis, among other factors. As a result, comparison shopping, negotiation, and collaboration with service providers and vendors have traditionally been time-consuming, inefficient, and costly for the buyer of network services. Specifically, the telecommunications industry has one of the most complex and tedious processes for network operators to look for end-to-end solutions, service providers, vendors, or implementers to help solve and implement their network operational business plans. Traditionally, telecommunication systems have been mainly hardware-based, wherein hardware devices were usually proprietary or managed by a specific vendor. Therefore, a network operator needs to carefully select appropriate vendors to provide network services to fulfil the network operator's needs. Further, different regions and customers have different requirements for network services, and it can be a challenging task for the network operator to select the appropriate network service providers or vendors that can fulfil all of its customers' need. Even after having selected the vendor or service provider, various types of arrangements will need to be made by the network operator in order to deploy or onboard the service (e.g., schedule site visits, on-site installation, etc.).

Further, the vendors are typically selected by the network operator, and the end user or customer of a particular service is not able to select the service provider(s) or vendor(s) he wants to work with. For instance, once an end user/customer chooses a network operator, the network services that are provided by the network operator will be bundled with the specific service provider(s) or vendors selected by the network operator, and not selected by the customer. Thus, if the customer is not satisfied with the service provider(s) or vendors, they may need to file a complaint to the network operator or may need to change to another network operator. Hence, there is a need to provide a solution to reduce or eliminate the network operator's burden of selecting service providers and on-boarding the network services, and to further provide flexibility to the end user or customer to choose the network services (and the respective providers) as per the customer's needs or requirements.

### SUMMARY

According to example embodiments, a centralized online marketplace, trading platform and network are provided that enable users to market and sell their network and telecommunication related services to customers who are looking to build solutions and run their business. In particular, the telecommunication network services can be defined and provided in software-based form or virtual network services, such as Virtualized Network Functions (VNFs) or Software Defined Networking (SDN), among others. Accordingly, the software-based and virtualized network services are stored (e.g., in a cloud cluster such as a hybrid cloud, data centers, etc.) via the marketplace platform of one or more embodiments. Here, the service providers of the marketplace platform can directly configure how they want to promote and sell their network services to customers. Similarly, the end users and customers can also customize the requirement of network services they wish to purchase and select the most appropriate service providers and specific vendors, as desired. In particular, the marketplace platform of one or more embodiments provides a centralized platform for a telecommunications related target market audience that is seeking solutions to run their business. By simplifying and automating the process, such as the process of capturing product interest to fulfilment and orchestration of order, both buyers and sellers of the marketplace platform can save time and resources as opposed to manual interventions, thereby automating the process and minimizing errors, and improving customer satisfaction, among other advantages. And through this automation, the marketplace platform can provide simple, flexible, cost-effective, efficient, and fast deployment of network solutions to customers.

According to example embodiments, a method of trading telecommunications related services on a centralized marketplace network includes: presenting a first telecommunications related service to a first user, wherein the first telecommunications related service is based on a configuration profile defined by a second user; receiving a selection for the first telecommunications related service by the first user; and receiving a purchase order request from the first user with respect to the selected first telecommunications related service.

The method may also include receiving input from the first user with respect to customizing or configuring the first telecommunications related service; receiving input from the first user to add the customized or configured first telecommunications related service to the purchase order request; and applying a price modification or reduction to the first telecommunications related service or the purchase order request. Here, the configuration profile may include the price modification or reduction, wherein the price modification or reduction is associated with the first user.

The method may also include receiving one or more identifying information with respect to the first user, wherein the identifying information is comprised of one or more: name, locations, company, job role, and contact time.

The method may also include receiving a request from the second user to access a dashboard portal. The dashboard portal may include at least one of: a product or service catalog portal, a customer lead or prospect information portal, a customer purchase history portal, or a product or service ordering portal.

The method may also include receiving a request from the second user to create a second telecommunications related product or service within the product or service catalog portal. Further, the created second telecommunications related product or service may be a software-based network service or a virtual network service.

The method may also include receiving a request from the second user to create one or more customer leads or prospects within the customer lead or prospect information portal. Further, the method may include receiving a request from the second user to create one or more promotional campaigns with respect to the second telecommunications related product or service based on the first user or a third user's purchase history from the customer purchase history portal or the product or service ordering portal. Here, the first user may be an end user and the second user may be a network service provider.

According to example embodiments, an apparatus for trading telecommunications related services on a centralized marketplace network, may include a memory storage storing computer-executable instructions; and a processor communicatively coupled to the memory storage, wherein the processor is configured to execute the computer-executable instructions and cause the apparatus to present, via a central server, a first telecommunications related service to a first user, wherein the first telecommunications related service is based on a configuration profile defined by a second user; receive, via the first user, a selection for the first telecommunications related service; and receive, via the first user, a purchase order request with respect to the selected first telecommunications related service or the selected first telecommunications related service.

In addition, the computer-executable instructions, when executed by the processor, may further cause the apparatus to receive input from the first user with respect to customizing or configuring the first telecommunications related service; receive input from the first user to add the customized or configured first telecommunications related service to the purchase order request; and apply a price modification or reduction to the first telecommunications related service or the purchase order request. Further, the configuration profile may further include the price modification or reduction, wherein the price modification or reduction is associated with the first user.

In addition, the computer-executable instructions, when executed by the processor, may further cause the apparatus to receive one or more identifying information with respect to the first user, wherein the identifying information is comprised of one or more: name, locations, company, job role, and contact time.

Further, the computer-executable instructions, when executed by the processor, may further cause the apparatus to receive, from the second user, a request to access a dashboard portal. Here, the dashboard portal may include at least one of: a product or service catalog portal, a customer lead or prospect information portal, a customer purchase history portal, or a product or service ordering portal.

Further, the computer-executable instructions, when executed by the processor, may further cause the apparatus to receive, from the second user, a request to create a second telecommunications related products or services within the product or service catalog portal. Here, the first user may be an end user and the second user may be a network service provider.

According to example embodiments, a non-transitory computer-readable medium includes computer-executable instructions for trading telecommunications related services on a centralized marketplace network by an apparatus, wherein the computer-executable instructions, when executed by at least one processor of the apparatus, cause the apparatus to present a first telecommunications related service to a first user, wherein the first telecommunications related service is based on a configuration profile defined by a second user; receive a selection for the first telecommunications related service by the first user; and receive a purchase order request from the first user with respect to the selected first telecommunications related service.

### BRIEF DESCRIPTION OF THE DRAWINGS

Features, advantages, and significance of exemplary embodiments of the disclosure will be described below with reference to the accompanying drawings, in which like signs denote like elements, and wherein:

FIG. 1 illustrates a diagram of a general system architecture according to one or more embodiments;

FIG. 2 illustrates a block diagram of a system for providing a centralized marketplace according to one or more embodiments;

FIG. 3 illustrates a flowchart of a method for a customer to utilize a centralized marketplace according to one or more embodiments;

FIG. 4 illustrates a flowchart of a method for a seller or network service provider to utilize a centralized marketplace according to one or more embodiments;

FIG. 5 illustrates a flowchart of a method for a user to utilize a centralized marketplace according to one or more embodiments;

FIGS. 6-8B illustrate graphical user interfaces for various non-limiting exemplary embodiments of a process of ordering telecommunications related services by an end user, buyer, or customer.

FIGS. 9-17B illustrate graphical user interfaces for various non-limiting exemplary embodiments of a process of managing and customizing telecommunications related services by a seller, network service provider, or vendor.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” “non-limiting exemplary embodiment,” or similar language means that a particular feature, structure, or characteristic described in connection with the indicated embodiment is included in at least one embodiment of the present solution. Thus, the phrases “in one embodiment”, “in an embodiment,” “in one non-limiting exemplary embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure can be practiced without one or more of the specific features or advantages of a particular embodiment. In other instances, additional features and advantages may be recognized in certain embodiments that may not be present in all embodiments of the present disclosure.

In one implementation of the disclosure described herein, a display page may include information residing in the computing device's memory, which may be transmitted from the computing device over a network to a database center and vice versa. The information may be stored in memory at each of the computing device, a data storage resided at the edge of the network, or on the servers at the database centers. A computing device or mobile device may receive non-transitory computer readable media, which may contain instructions, logic, data, or code that may be stored in persistent or temporary memory of the mobile device, or may somehow affect or initiate action by a mobile device. Similarly, one or more servers may communicate with one or more mobile devices across a network, and may transmit computer files residing in memory. The network, for example, can include the Internet, wireless communication network, or any other network for connecting one or more mobile devices to one or more servers.

Any discussion of a computing or mobile device may also apply to any type of networked device, including but not limited to mobile devices and phones such as cellular phones (e.g., any “smart phone”), a personal computer, server computer, or laptop computer; personal digital assistants (PDAs); a roaming device, such as a network-connected roaming device; a wireless device such as a wireless email device or other device capable of communicating wireless with a computer network; or any other type of network device that may communicate over a network and handle electronic transactions. Any discussion of any mobile device mentioned may also apply to other devices, such as devices including short-range ultra-high frequency (UHF) device, near-field communication (NFC), infrared (IR), and Wi-Fi functionality, among others.

Phrases and terms similar to “software”, “application”, “app”, and “firmware” may include any non-transitory computer readable medium storing thereon a program, which when executed by a computer, causes the computer to perform a method, function, or control operation.

Phrases and terms similar to “network” may include one or more data links that enable the transport of electronic data between computer systems and/or modules. When information is transferred or provided over a network or another communications connection (either hardwired, wireless, or a combination of hardwired or wireless) to a computer, the computer uses that connection as a computer-readable medium. Thus, by way of example, and not limitation, computer-readable media can also include a network or data links which can be used to carry or store desired program code means in the form of computer-executable instructions or data structures and which can be accessed by a general purpose or special purpose computer.

Phrases and terms similar to “portal” or “terminal” may include an intranet page, internet page, locally residing software or application, mobile device graphical user interface, or digital presentation for a user. The portal may also be any graphical user interface for accessing various modules, components, features, options, and/or attributes of the disclosure described herein. For example, the portal can be a web page accessed with a web browser, mobile device application, or any application or software residing on a computing device.

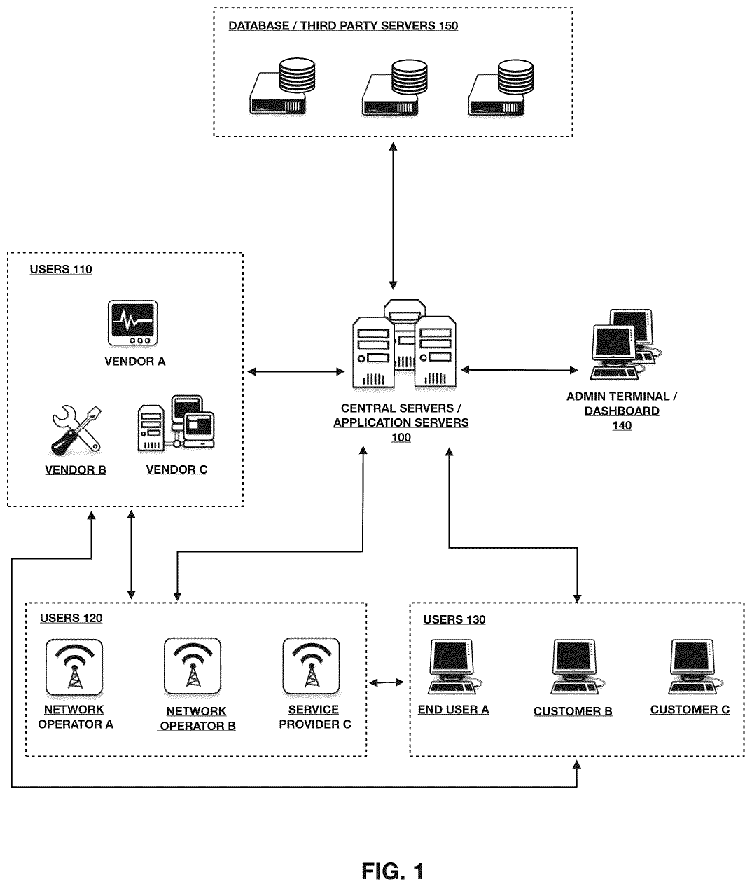

FIG. 1 illustrates a diagram of a general network architecture according to one or more embodiments. Referring to FIG. 1, users 110, 120, and 130 can be in bi-directional communication over a secure network with central servers or application servers 100 according to one or more embodiments. In addition, users 110, 120, 130 may also be in direct bi-directional communication with each other via the marketplace platform network system according to one or more embodiments. Here, users 110 can be any type of vendor or service provider, such as vendors A, B, and C offering to either users 120 or users 130 similar, same, or different services or products with respect to a network or service operator. In particular, users 110 can provide any type of telecommunications related service or product, such as cellular service network deployment, network capacity update, operational monitoring, data analytic and reporting, and any other suitable services. Each of users 110 can communicate with servers 100 via their respective terminals or portals. Users 120 can be network operators A and B and service provider C, which may offer similar, same, or different services or products to users 130 or users 110. Here, users 110 or 120 can be any type of telecommunications vendor or network service provider, network operator, carrier, broadband provider, Unified Communications as a Service (UCaaS) providers, wired or wireless cellular network service provider, radio access network (RAN), web host, or any network or telecommunications related service or network provider, among others. Each of users 120 can communicate with servers 100 via their respective terminals or portals. Users 130 can be any type of end user or customer of users 120 or users 110, such as end user A or customers B and C, or the end user purchasing and/or receiving the telecommunications network related services of users 110 or users 120. Each of users 130 can communicate with servers 100 via their respective terminals or portals.

Still referring to FIG. 1, central servers 100 of the marketplace platform system according to one or more embodiments can be in further bi-directional communication with admin terminal/dashboard 140. Here, admin terminal/dashboard 140 can provide various tools to any of users 110, 120, and 130, or a sales team or a content/product creation team to manage various customers/end users and customer leads, wherein such managing can include, among others, creating, editing, and promoting various types of telecommunications network services or product sales promotional campaigns, advertising, offerings, and ordering options for customers and other users of the marketplace platform according to one or more embodiments. In addition, admin terminal/dashboard 140 may also include various types of access privileges to different users of the marketplace platform system according to one or more embodiments. Further, central servers 100 according to one or more embodiments can be in further bi-directional communication with database/third party servers 150. Here, servers 150 can provide various types of data storage (such as cloud-based storage), web services, content creation tools, data streams, data feeds, and/or provide various types of third-party support services to central servers 100 of the marketplace platform. However, it is contemplated within the scope of the present disclosure described herein that the network services marketplace platform process and system according to one or more embodiments can include any type of general network architecture.

Still referring to FIG. 1, one or more of servers or terminals of elements 100-150 may include a personal computer (PC), a printed circuit board comprising a computing device, a mini-computer, a mainframe computer, a microcomputer, a telephonic computing device, a wired/wireless computing device (e.g., a smartphone, a personal digital assistant (PDA)), a laptop, a tablet, a smart device, a wearable device, or any other similar functioning device.

In some embodiments, as shown in FIG. 1, one or more servers, terminals, and users 100-150 may include a set of components, such as a processor, a memory, a storage component, an input component, an output component, a communication interface, and a JSON UI rendering component. The set of components of the device may be communicatively coupled via a bus.

The bus may comprise one or more components that permit communication among the set of components of one or more of servers or terminals of elements 100-150. For example, the bus may be a communication bus, a cross-over bar, a network, or the like. The bus may be implemented using single or multiple (two or more) connections between the set of components of one or more of servers or terminals of elements 100-150. The disclosure is not limited in this regard.

One or more of servers or terminals of elements 100-150 may comprise one or more processors. The one or more processors may be implemented in hardware, firmware, and/or a combination of hardware and software. For example, the one or more processors may comprise a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), a general purpose single-chip or multi-chip processor, or other programmable logic device, discrete gate or transistor logic, discrete hardware components, or any combination thereof designed to perform the functions described herein. A general purpose processor may be a microprocessor, or any conventional processor, controller, microcontroller, or state machine. The one or more processors also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function.

The one or more processors may control overall operation of one or more of servers or terminals of elements 100-150 and/or of the set of components of one or more of servers or terminals of elements 100-150 (e.g., memory, storage component, input component, output component, communication interface, rendering component).

One or more of servers or terminals of elements 100-150 may further comprise memory. In some embodiments, the memory may comprise a random access memory (RAM), a read only memory (ROM), an electrically erasable programmable ROM (EEPROM), a flash memory, a magnetic memory, an optical memory, and/or another type of dynamic or static storage device. The memory may store information and/or instructions for use (e.g., execution) by the processor.

A storage component of one or more of servers or terminals of elements 100-150 may store information and/or computer-readable instructions and/or code related to the operation and use of one or more of servers or terminals of elements 100-150. For example, the storage component may include a hard disk (e.g., a magnetic disk, an optical disk, a magneto-optic disk, and/or a solid state disk), a compact disc (CD), a digital versatile disc (DVD), a universal serial bus (USB) flash drive, a Personal Computer Memory Card International Association (PCMCIA) card, a floppy disk, a cartridge, a magnetic tape, and/or another type of non-transitory computer-readable medium, along with a corresponding drive.

One or more of servers or terminals of elements 100-150 may further comprise an input component. The input component may include one or more components that permit one or more of servers and terminals 110-140 to receive information, such as via user input (e.g., a touch screen, a keyboard, a keypad, a mouse, a stylus, a button, a switch, a microphone, a camera, and the like). Alternatively or additionally, the input component may include a sensor for sensing information (e.g., a global positioning system (GPS) component, an accelerometer, a gyroscope, an actuator, and the like).

An output component any one or more of servers or terminals of elements 100-150 may include one or more components that may provide output information from the device 100 (e.g., a display, a liquid crystal display (LCD), light-emitting diodes (LEDs), organic light emitting diodes (OLEDs), a haptic feedback device, a speaker, and the like).

One or more of servers or terminals of elements 100-150 may further comprise a communication interface. The communication interface may include a receiver component, a transmitter component, and/or a transceiver component. The communication interface may enable one or more of servers or terminals of elements 100-150 to establish connections and/or transfer communications with other devices (e.g., a server, another device). The communications may be enabled via a wired connection, a wireless connection, or a combination of wired and wireless connections. The communication interface may permit one or more of servers or terminals of elements 100-150 to receive information from another device and/or provide information to another device. In some embodiments, the communication interface may provide for communications with another device via a network, such as a local area network (LAN), a wide area network (WAN), a metropolitan area network (MAN), a private network, an ad hoc network, an intranet, the Internet, a fiber optic-based network, a cellular network (e.g., a fifth generation (5G) network, a long-term evolution (LTE) network, a third generation (3G) network, a code division multiple access (CDMA) network, and the like), a public land mobile network (PLMN), a telephone network (e.g., the Public Switched Telephone Network (PSTN)), or the like, and/or a combination of these or other types of networks. Alternatively or additionally, the communication interface may provide for communications with another device via a device-to-device (D2D) communication link, such as FlashLinQ, WiMedia, Bluetooth, ZigBee, Wi-Fi, LTE, 5G, and the like. In other embodiments, the communication interface may include an Ethernet interface, an optical interface, a coaxial interface, an infrared interface, a radio frequency (RF) interface, or the like.

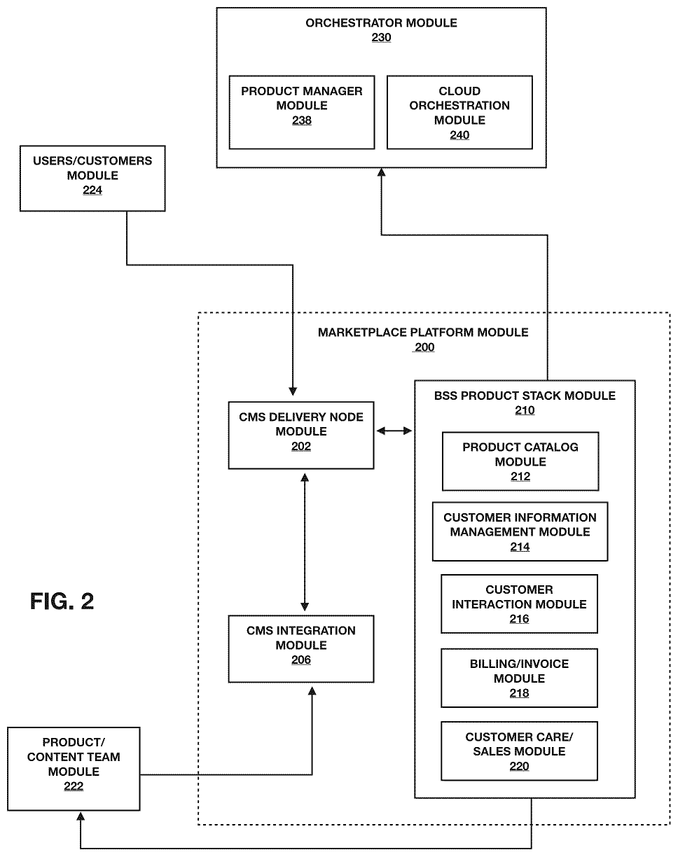

FIG. 2 illustrates a telecommunications network services marketplace and trading platform system according to one or more embodiments. Referring to FIG. 2, marketplace platform module or portal 200 can include a Customer Management System (CMS) delivery node module 202 which can be a portal for the marketplace platform and is in bidirectional communication with a Business Support Systems (BSS) product stack module or portal 210 (including any one or more of modules 212-220 illustrated in FIG. 2), and a CMS integration module or portal 206 for content management and integrating with various repositories. Users/customers module or portal 224 (e.g., a user terminal or client device) can access the marketplace via communication with CMS delivery node module or portal 202. In some embodiments, users/customers module or portal 224 can also be in communication with a Content Distribution Network (CDN) module or portal which is further in communication with modules or portals 202 and 206. In some embodiments, the CMS delivery node module or portal 202 can address a first customer interaction when the customer accesses the marketplace platform 200 according to one or more embodiments. For example, the CMS delivery node module or portal 202 can receive a request from a user terminal or portal 224 of the customer to view the available products/services, retrieve product/service data from a product catalog, and generate/present a user interface graphical representation (e.g., column, list, etc.) illustrating available products/services of the marketplace platform or of one or more service providers or vendors. In addition, a product/content team module or portal 222 (e.g., a terminal or client devices of a seller, service provider, vendor, etc.) may also be in communication with the marketplace platform module or portal via communication with the CMS integration module or portal 206. In this case, the CMS integration module or portal 206 can generate and/or present graphical user interfaces relevant to a seller, service provider, vendor, etc. (e.g., user interfaces for listing products for sale, configuring sales listings, generating or editing customer or product configuration profiles, promoting sales activity, etc.).

It is contemplated within the scope of the present disclosure described herein that any user of the marketplace platform can first login to a user management platform to determine the type or role of user or the access privileges of that user, such as the appropriate users for modules or portals 222, or 224. For instance, a login page will be generated by the user management platform and then be presented to the user via the respective modules or portals 222, or 224, to allow the user to input user's credentials for login to the marketplace platform. The user's credentials will be provided to the user management platform to determine the type or role of user or the access privileges of that user. Once the user management platform determines that the user is a service provider/vendor/seller (accessing the marketplace platform via product/content team module 222), the user management platform can connect product/content team module 222 to the CMS integration module 206. Similarly, if the user management platform determines that the user is a customer/buyer (accessing the marketplace platform via a users/customers module 224), the user management platform can connect users/customers module 224 to the CMS delivery node module 202.

Still referring to FIG. 2, the marketplace platform module or portal 200 according to one or more embodiments may also include the BSS product stack module or portal 210. Here, module 210 may further include a product catalog module or portal 212 which can be a repository/data storage for storing product/service data. Further, module 212 may also include and store product/service level promotional offers or price reduction indicators or events associated with one or more stored products/services. Module 210 may also include a customer information management (CIM) module or portal 214 which can be a repository/data storage for storing customer information (e.g., name, contact information, ID, customer interest list, customer level promotional offers or price reduction events, etc.). Module 210 may also include a customer interaction management module or portal 216 which can be a repository/data storage for storing information of the customer's interaction with the marketplace platform according to one or more embodiments (e.g., the interaction history of the customer with the interactive elements of the graphical user interface (GUI), communications between the customer and the service provider(s) or other customer(s), etc.)

Still referring to FIG. 2, module 210 can also include a billing/invoice module or portal 218 for storing information associated with the customer's billing/invoicing on a service provided in the marketplace platform (e.g., previously created invoice, billing history, etc.). In addition, module 210 may also include a customer care/sales module or portal 220 for storing information of the sales or customer related activities (e.g., sales campaign history, promotion activities for a specific type of customer, historical sales analysis, etc.). In some embodiments, module 220 can identify data associated with sales activity and user's experiences, retrieve/collect the data from external data storages or from any of modules or portals 212-218, store such data in a repository included in module 220, and provide such data to the network service provider/vendor when required. As shown, module 220 can also be in communication with the product/content team module or portal 222. Here, the product/content team module or portal 222 can be users or a portal for users (e.g., vendors/service providers) who want to promote/sell network services. In addition, product/content team module or portal 222 can be a lead converter system or users who want to convert customer leads, analyze customer activity, and promote pre-sales and post-sales activities and marketing campaigns.

Still referring to FIG. 2, the marketplace platform module or portal 200 may also be in communication with an orchestrator module 230 (e.g., via an Application Programming Interface (API)). In particular, any one or more of modules or portals 212-220 of module 210 may be in communication with and/or supported by any of modules or portals 238-240 of module 230. Specifically, orchestrator module 230 can include a product/service management module 238 and a cloud orchestration module 240. In particular, any of modules 238-240 can be containerized and stored in a “cloud” or within cloud clusters on external servers and databases. In some embodiments, product/service management module 238 comprises a repository/data storage for storing products and services provided by a vendor/service provider. In some embodiments, the products and services are virtualized or are software-based. In some embodiments, the cloud orchestration module 240 is configured to schedule and provide the products and services to a user of the network services marketplace platform.

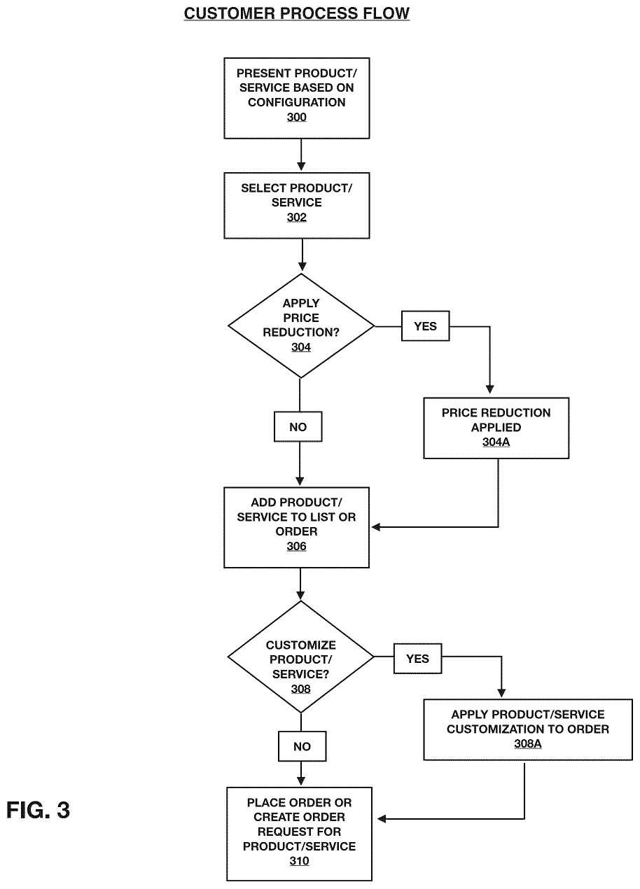

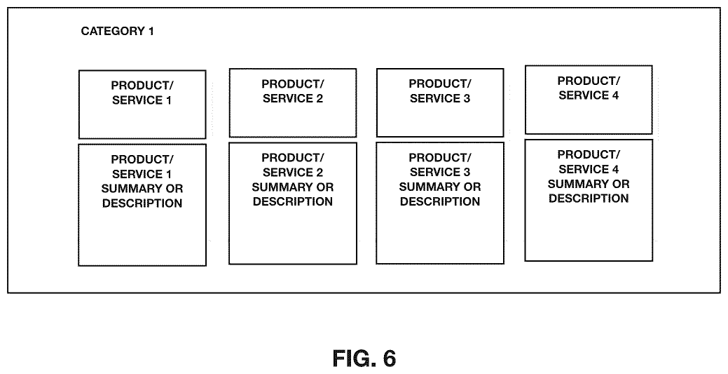

FIG. 3 illustrates a process flow for a customer using the network services marketplace platform according to one or more embodiments. Referring to FIG. 3, at step 300, the user (such as a customer, potential customer, or end user) can access a portal of the marketplace platform (such as accessing CMS delivery node module 202 via the users/customers module 224) and be presented with a product/service based on a prior defined configuration profile by a service provider or vendor for that customer or a particular product. In particular, at step 300, the CMS delivery node module 202 receives (via the users/customers module 224) a request from the user to view the available products/services, retrieves product/service data from the product catalog module 212 based on the request, and generates/presents a graphical user interface (GUI) representation (e.g., column, list, etc.) illustrating available products/services of the marketplace platform or of one or more service providers or vendors. Referring to FIGS. 6-8B, for exemplary purposes, “product/service 1” can be an available telecommunications network related service or product presented to the user for purchase.

At step 302, the user can select a service or product in the list/catalog via the GUI, and the marketplace platform system can receive the user's selection of the service or product. In particular, an indicator defining the selected product/service is sent from the users/customers module 224 to the CMS delivery node module 202 of the marketplace platform, and the CMS delivery node module 202 can then retrieve a configuration profile of the selected product or service from a respective data storage (such as the product catalog module 212), generate a service detail page based on the configuration profile, and send the generated service detail page to the users/customers module 224 to further present the page to the user. The configuration profile can be created, defined, or pre-defined by the vendor or service provider for defining how specifically the service/product should be promoted/presented on the marketplace platform to the customer or end user (such as a specific customer, a set/group of customers, or customers interested in particular products/services, etc.). For example, the configuration profile can be criteria-based. Thus, the details of the service/product can include any suitable information.

Still referring to FIG. 3, at step 304, the marketplace platform or the user can optionally decide whether to apply a price reduction to the selected service/product. If yes, then the CMS delivery node module 202 will retrieve price reduction information (e.g., from the product catalog module 212 and/or customer information management module 214, etc.) and apply the price reduction to the original price of the selected service/product at step 304A and then proceeds to step 306. If no, then the process proceeds to step 306 without applying any price reduction. In particular, the price of a particular service/product may be different depending on the user or type of user (e.g., end user, vendor, etc.). In particular, a network service provider/vendor may provide a user a price reduction indicator, option, or code (e.g., discount coupon, time-based sales indicator, indicator for obtaining special offer or promotional discounts for special user such as internal users or users who have complained of previous service, etc.), wherein the price reduction indicator can be presented on a per product/service basis (e.g., receive price reduction for only a specific product/service) or on a per user basis (e.g., receive price reduction for all services viewed by a user). In some embodiments, the price reduction indicator on the per product/service basis is stored in the product catalog module 212, and the price reduction indicator on the per user basis is stored in the customer information management module 214. Thus, when the user logs in to the marketplace platform to select the particular service/product, the CMS delivery node module 202 of marketplace platform can retrieve the price reduction indicator associated with the user login information from the respective data storage (e.g., the product catalog module 212, customer information management module 214, etc.), apply the price reduction to the original price of the service (set by the service provider), and present the reduced price on the page.

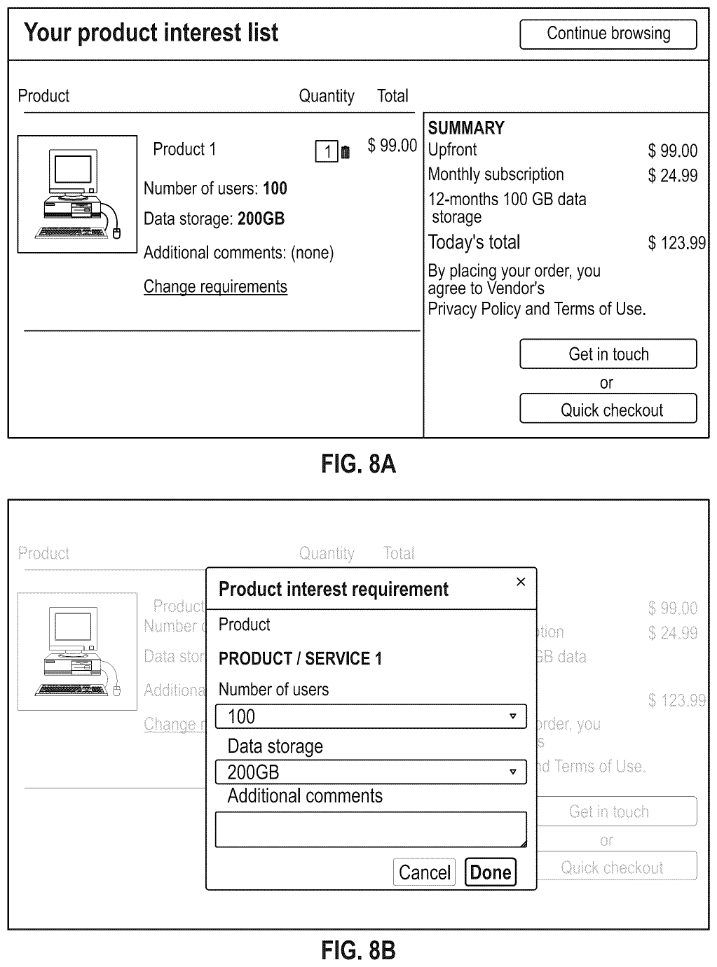

Still referring to FIG. 3, at step 306, the marketplace platform can receive a selection by the user that he/she would like to add a particular selected service/product to a “product interest list” or an order list for purchase, wherein such information can be stored within (or retrieved from) the customer information management module 214. In particular, if the user is interested in a selected service/product or would like to purchase/order/shortlist the service/product, the user can trigger an interactive element (e.g., a dedicated button such as “Add to purchase list”, “Add to interest list”, or any other suitable GUI element) within the portal of the marketplace platform. The marketplace platform can then add the configuration profile of the selected service to an interest list of the user, compute the information of the selected service(s)/product(s), provide a fee summary of the selected services/products, and further generate and present via the GUI an interest list to the user. Referring to FIG. 8A, for exemplary purposes, an interest list GUI is shown via a portal of the marketplace platform.

Still referring to FIG. 3, at step 308, the user can decide whether to customize the selected product/service. If yes, then at step 308A, the CMS delivery node module 202 receives a product/service customization from the users/customers module 224 and applies the product/service customization to the list or order, and the process proceeds to step 310. If no, then the process proceeds to step 310 without applying any product/service customization. Here, the user can choose to customize the service/product order (by triggering an interactive element such as a dedicated button “Change requirements”, etc.) as per the user's requirement and to send the order request (e.g., when the requested order is not available, or when the user is a new customer) to the service provider or seller by triggering an interactive element (e.g., a dedicated button “Get in touch” or any GUI element), or to purchase the service/product (if the service/product is available and the customer's detail/identification/purchase history of the user has registered previously) by triggering an interactive element (e.g., a dedicated button “Quick checkout” or any GUI element). Referring to FIG. 8B, for exemplary purposes, the customization option(s) and process is shown via a GUI portal of the marketplace platform. Here, such interactions between the user and the marketplace platform can be stored within (or retrieved from) the customer interaction module 216.

Still referring to FIG. 3, at step 310, the CMS delivery node module 202 of marketplace platform can receive a selection from the user to order the selected service/product or to send a request for the customized service/product. In particular, if the user chooses to purchase the selected service/product (e.g., by triggering or selecting the “Quick Checkout” button or any GUI element), and the CMS delivery node module 202 determines (e.g., based on data retrieved from the product catalog module 212) that the user is logged into the marketplace platform (the detail/identification/purchase history of the user has registered previously) and the selected service/product is predefined and is available, the CMS delivery node module 202 can generate and present a purchase page to the user. The price can be computed based on the price defined by the service provider in the configuration profile, the price reduction indicator(s) retrieved from the product catalog module, the customer information management module, and/or other data storage (if any), and the customization made by the user via the interest list. Further, the user can review and modify his personal information (e.g., name, designation, company, contact info, etc.) and payment method (e.g., credit/debit card, bank transfer, payment with reward points, etc.). If the marketplace platform determines that the user is a Guest user, the marketplace platform can direct the user to the user management system, and the user management system will generate and present a login page to request the user to login, before the marketplace platform presents the purchase page or GIU portal to the user. After confirming the purchase details, the user triggers or selects an interactive element (e.g., a dedicated button “Pay” or any GUI element, etc.), the CMS delivery node module 202 will send a payment request to the billing/invoice module 218, such that the billing/invoice module 218 will collect the associated billing and charging data stored within the billing/invoice module 218 and generate a payment information based on the billing and charging data and the payment request. Subsequently, the billing/invoice module 218 will then send the payment information to a billing team or external payment platform to process the payment. Once payment has been successful, the billing team or external payment platform will generate an invoice containing an order reference ID and send the same to the billing/invoice module 218. The billing/invoice module 218 will store a copy of the generated invoice in a repository within the billing/invoice module 218, and then send the invoice to CMS delivery node module 202. The CMS delivery node module will then present the invoice (or only the order reference ID) to the user via users/customers module 224.

Still referring to FIG. 3, at step 310, if the user chooses to place an order request for the selected service (e.g., by triggering the “Get in touch” button or any GUI element) and the marketplace platform determines that the user is a “guest” user, the CMS delivery node module 202 will direct the user to the user management system, and the user management system will generate and present a page requesting the user to login (for registered customer) or create an order request (for new customers). If the user is a new customer, the user can trigger the dedicated button (e.g., “Create an order request” or any GUI element). The user management system will then notify the CMS delivery node module to generate and present an order request creation page or GUI portal to the user. The page or GUI portal can include multiple input fields to allow the user to specify his/her background info (e.g., company, location, name, contact info, job role, contact time, etc.). In some embodiments, such information can be stored within (or retrieved from) the customer information management module 214. In one embodiment, the input fields can be prepopulated by the marketplace platform (e.g., based on the location information of the user, etc.). After confirming the user's information details, the user can trigger or select an interactive element (e.g., a dedicated button “Submit” or any GUI element), the marketplace platform will then send the order information to a sales team to process the order request, such as via the billing/invoice module 218 as described in above. In some embodiments, the CMS delivery node module 202 will send the inputted user's information to the user management platform for creating a new user account for the new customer. Subsequently, the user management platform will provide the user's information (e.g., user's purchase history, etc.) to the CMS delivery node module 202, and the CMS delivery node module 202 will then store the user's information in the respective module(s) of BSS product stack module 210.

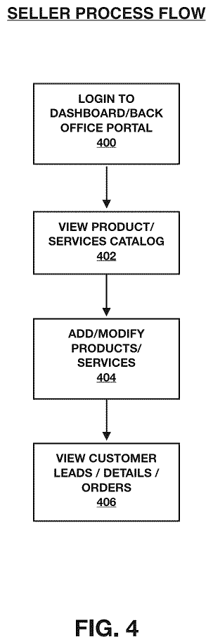

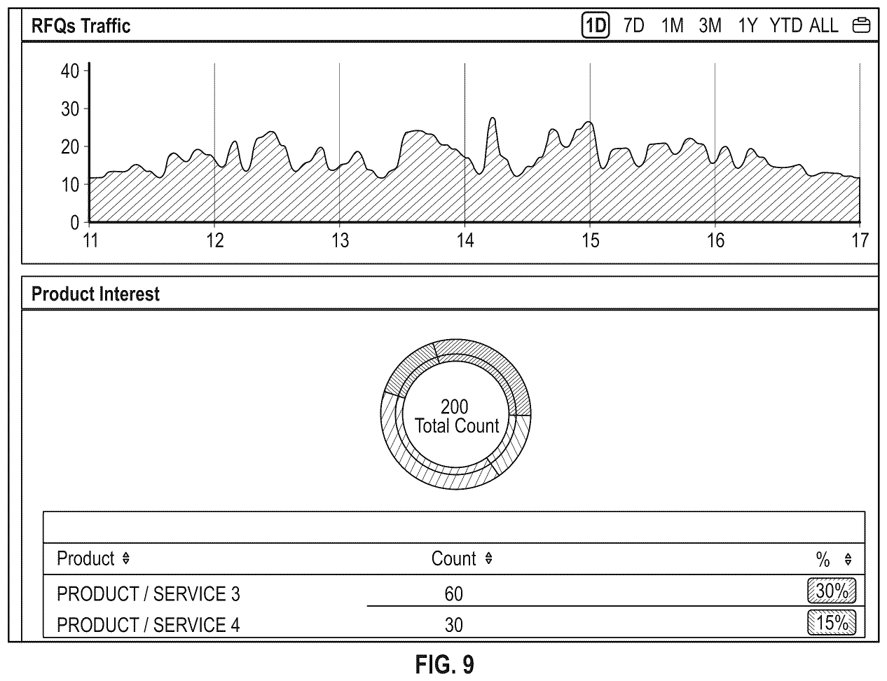

FIG. 4 illustrates a process flow for a seller or service provider/vendor using the network services marketplace platform according to one or more embodiments. Referring to FIG. 4, at step 400, the user (such as a network service provider or vendor), can be presented with a login GUI portal where the user can login to a dashboard/admin/back-office portal of the marketplace platform according to one or more embodiments, such as via the product/content team module 222 as discussed above. Specifically, after successful login, the product/content team module 222 will be connected to the CMS integration module 206, and the CMS integration module 206 will collect information from BSS product stack module 210 via CMS delivery node module 202, and will then generate and present said information to the user via a dashboard or back-office GUI portal. Here, information pertaining to the users (e.g., buyer, sellers, etc.) can be stored and managed within one or more modules 212-220 within BSS product stack module 210, and/or within any other suitable repository. In particular, the back-office portal can include a dashboard page/portal, a product catalog page/portal, a customer's leads page/portal, a customer's details or identification or purchase history page/portal, and an order page/portal. The user can opt to navigate among the various pages/portals/sub-portals by triggering or selecting a respective interactive element (e.g., button, shortcut key, etc., or any GUI element). In addition, the dashboard page/portal includes graphical presentations (e.g., GUI, graphs, chart, etc.) that illustrate status of service(s) associated with the user. For example, a request for quote (RFQ) traffic and product interest of the service (e.g., “product/service 1” as previously described above) can be provided to the user via the dashboard page/portal, such as exemplified in FIG. 9.

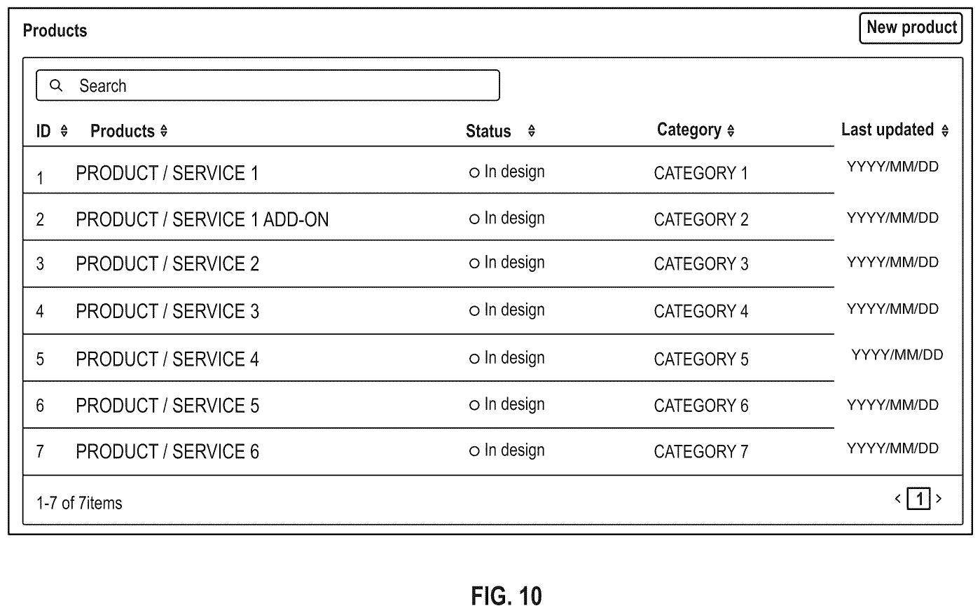

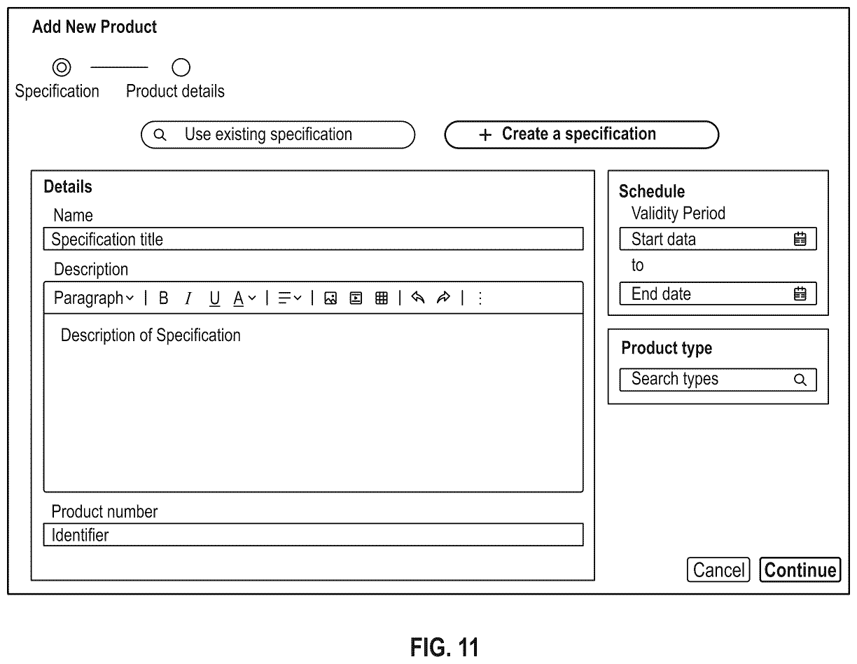

Still referring to FIG. 4, at step 402, the CMS integration module 206 can generate (e.g., based on information retrieved from the product catalog module 212) and present (via the product/content team module 222) to the user (e.g., service provider, vendor, or seller) various services/products associated with the user, such as a product catalog page/portal as exemplified in FIG. 10. In particular, the product catalog page/portal includes sub-pages/sub-portals such as catalogs (e.g., groups, such as products for company A, including among others, 4G network services, 5G network services, etc.), categories (e.g., cloud service associated with company A, operational services associated with 4G services, digital experience services associated with 5G network services, etc.), products (products A-C associated with cloud service, etc.), details (specification of product A, etc.). Here, such products/services can be any type of hardware or software based or virtualized network related services products, such as software Virtualized Network Functions (VNFs) and/or Software Defined Networking (SDN) products or services. In addition, further categories can include access services, cloud services, operations services, unified cloud services, network functions services, intelligent operations services, digital experience services, and internet/ecosystem services, among others. Additional products or services can include Cloud-RAN wide-scale deployment testing and development projects, virtualized NFC-compatible virtual Base Station solutions for both in-building wireless and macro-networks, end-to-end flexible RAN solutions for projects including rural network deployment, indoor connectivity, fixed access, backhaul and IoT applications, indoor and outdoor massive MIMO, macro and small cells, interference management and dual connectivity to improve network performance, basebands, radio processors and radio access processing platforms, network design and optimization services, among others. At step 404, the user can also add, modify, and remove various types of product/service offerings and promotional campaigns, via the product catalog page/portal such as exemplified in FIGS. 11-14 for exemplary purposes. In some embodiments, the user can also add new catalogs, new categories, new products, and new specifications via the respective sub-pages according to one or more embodiments. In addition, the user can also modify the created catalogs, categories, products, and specifications via the respective sub-pages.

Still referring to FIG. 4, at step 406, the CMS integration module 206 can retrieve (from the customer information management module 214, customer interaction module 216, and/or any other suitable repository) and present to the user (via the product/content team module 222) various types of customer leads/prospects, customer information, customer identification, customer interest list, and customer orders/purchase history. In particular, a customer lead or prospects page/portal sub-page shows the person in charge/representative from each business partner/customer who has connected with the user or is in communication with user (e.g., service provider or vendor). Here, the user can view the information of the customer lead or prospect within the leads sub-page or sub-portal, modify the info of the customer lead included in this sub-page and further add new or additional leads or prospects to this sub-page. In particular, the customers sub-page or sub-portal can show the customers (specific customers from an association/company, individual customer, etc.) associated with the services/products that are provided/managed/offered by the user (e.g., serviced provider or vendor). The user can view the information of the customers in this sub-page, modify the info of the customers included in this sub-page, and add new customers to this sub-page or sub-portal.

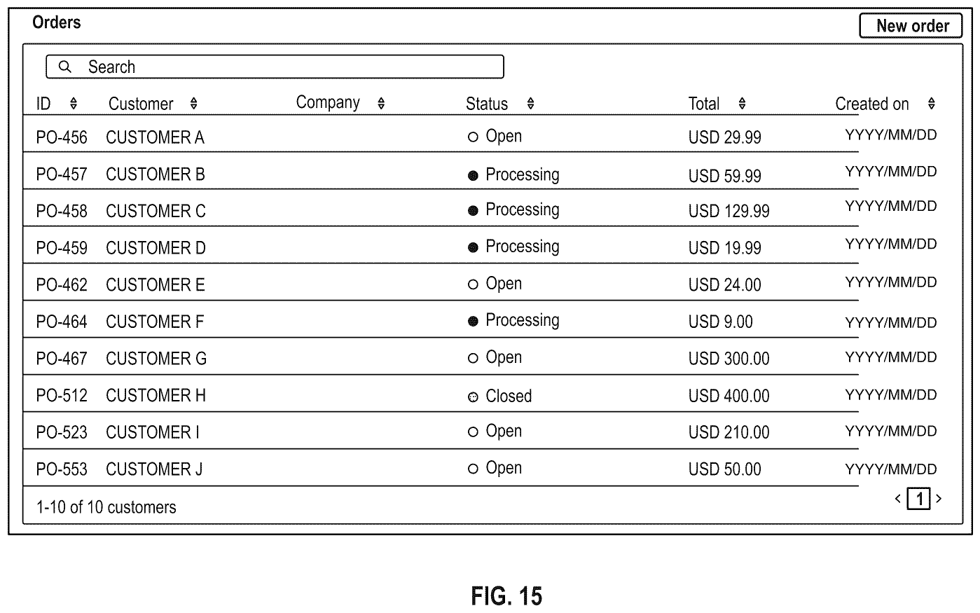

Still referring to FIG. 4, at step 406, the CMS integration module 206 retrieves (from the customer interaction module 216, billing/invoice module 218, customer care/sales module 220, etc.) and presents in an orders sub-page/sub-portal the orders associated with the service/products that are provided/offered/managed by the user (e.g., service provider or vendor). Here, the user can view the information of the orders in this sub-page, modify the info of the orders included in this sub-page/sub-portal, and add new orders to this sub-page/sub-portal, such as shown in FIGS. 15-17B for exemplary purposes. Further, in other embodiments, once the user receives an order request from a customer, the user can use the back-office to customize the service/product based on the customer's requirement and then publish the service/product to the marketplace platform such that the customized service/product can be selected/purchased by other users. The custom configuration parameters inputted by the user can be saved in data storage (e.g., the product catalog module 212, customer information management module 214, or any other suitable repository) as a configuration profile, such that when another customer accesses the marketplace platform the marketplace platform can retrieve the configuration profile for the customer and present the service/product to the customer based on the configuration profile associated with the customer. Once the customized service is ready, the user can store/onboard the service/product via the marketplace platform such that the orchestrator (such as orchestrator module 230 of FIG. 2) of the marketplace platform can schedule the provision of the service/product to the customer. Here, the foregoing customer information may be stored within (or retrieved from) the customer information management module 214, the customer interaction module 216, and any other suitable repository.

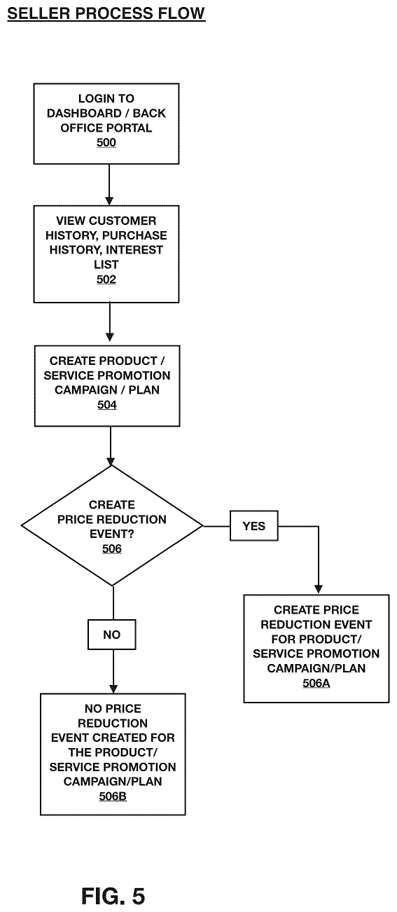

FIG. 5 illustrates a process flow for a user (such as a service provider/vendor) using the network services marketplace platform according to one or more embodiments. Referring to FIG. 5, at step 500, the user (e.g., a seller, vendor, service provider, etc.) can be presented with a login GUI portal of the user management platform where the user can login to a dashboard/admin/back-office portal of the marketplace platform according to one or more embodiments, such as via the product/content team module 222 as discussed above. After successful login, the product/content team module 222 will be connected to the BSS product stack module 210. Further, the product/content team module 222 can retrieve (from any modules 212-220 of BSS product stack module 210) any information which may be helpful in constructing a sales activity or promotion plan. The user can then use the information to construct a sales activity or a promotion plan.

Next, at step 502, the product/content team module 222 will retrieve (from customer information management module 214, customer interaction module 216, and/or any other suitable repository) and present to the user a customer information, view history, purchase history, and interest list, among others. In particular, the view history, purchase history, interest list, etc., of a registered customer of the marketplace platform can be forwarded by the BSS product stack module 210 of marketplace platform to the product/content team module 222 (e.g., a user's terminal of a service provider/vendor/internal content team). Here, the view history, purchase history, interest list, etc., sub-page/sub-portal of a registered customer can be taken into consideration by the user in creating the sales/promotion plan, according to the information of the registered customer (e.g., role/company/location, etc.). For example, registered customer A has role A in Company A, wherein the marketplace platform can provide information pertaining to another registered customer B who has role A in Company A, information of another registered customer C who has role A in Company Z, and information of another registered customer D who has role B in Company A, etc., to the user (e.g. a network service provider/vendor) for consideration, such that the user can more accurately promote (e.g., suggest related product, arrange price scale, etc.) services to either registered customers (users) A, B, C, or D.

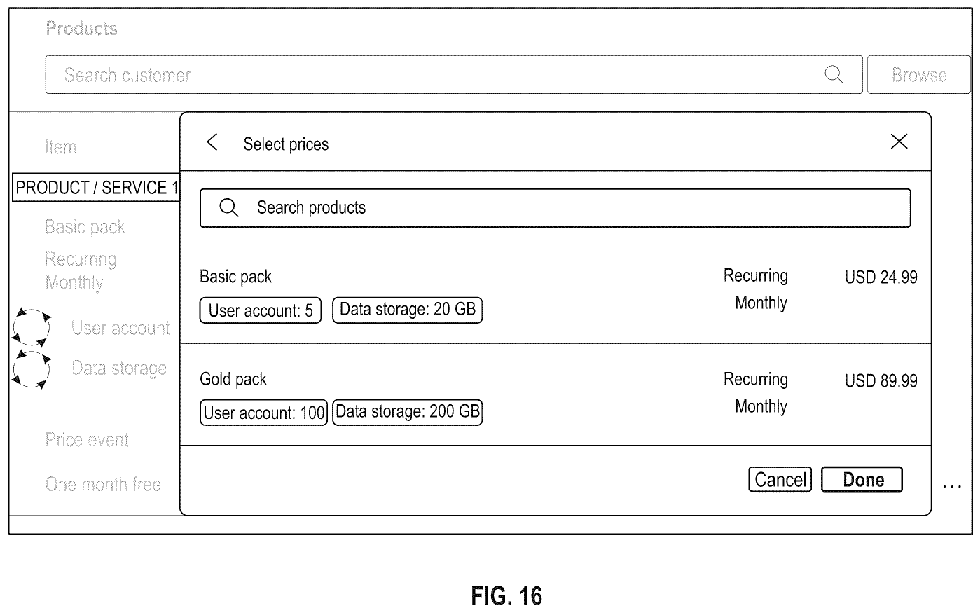

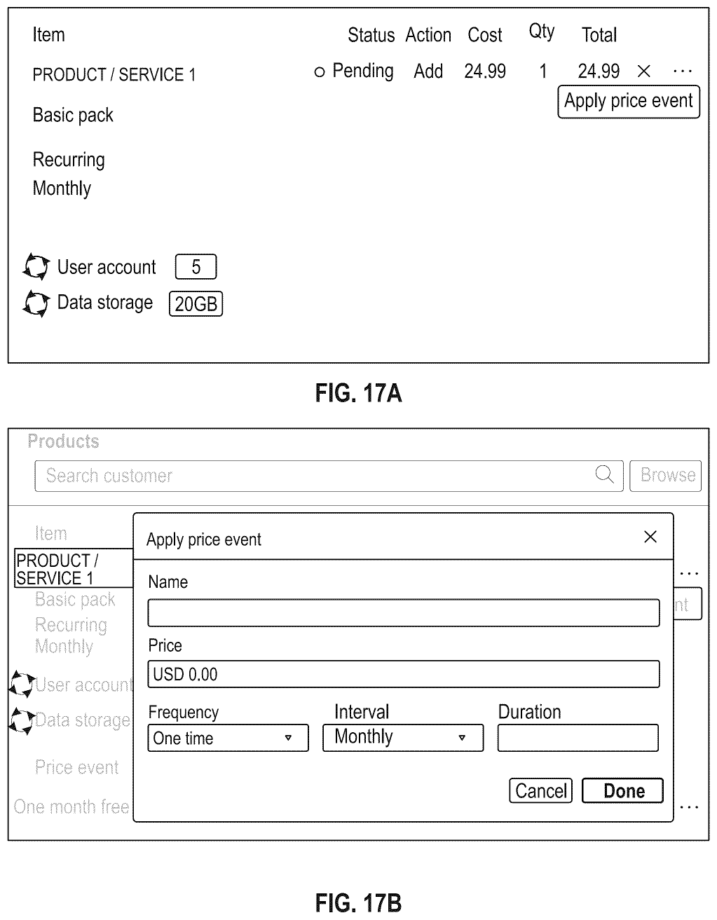

Still referring to FIG. 5, at step 504, the product/content team module 222 can receive a selection from the user to create a promotion campaign plan for a product/service available in the marketplace platform (e.g., product/service available in the product catalog module 212). In particular, the user or the marketplace platform can analyze the received customer historical information (such as via the information retrieved from the customer management module 214, customer interaction module 216, etc.) and/or the received sales historical information (such as analysis of sales history retrieved from the customer care/sales module 220), and then construct a plan to promote/market/sell service(s) or product(s) to the registered customer based thereon. At step 506, the user may decide (via product/content team module 222) whether to optionally create a price reduction/modification indicator or event for a particular service/product and/or for a particular user/user group. If yes, then at step 506A, the process or the user creates the price reduction event with respect to the product/service and the promotional campaign or plan, such as via the product catalog module 212. If no, then at step 506B, the process or user does not create any a price reduction event with respect to the product/service and the promotional campaign or plan. In particular, the user can create a price reduction event for a specific catalog/category/product/service (e.g., for customers interested in said specific catalog/category/product/service will receives the price reduction), and provide a price reduction offer to a specific workgroup/user/customer, or a combination thereof. Referring to FIGS. 16-17B, for exemplary purposes, the dashboard page and the price reduction/modification process, among others, are shown with respect to various GUI portals (or screens) according to one or more embodiments.

FIG. 6 illustrates one non-limiting exemplary embodiment of a GUI portal of a list/catalog of available network products/services of the network services marketplace platform. From here, a user may select a network product/service which he is interested with. The GUI portal shown in FIG. 6 may be generated and/or populated by the CMS delivery node 202 based on product/service data retrieved from the product catalog module 212.

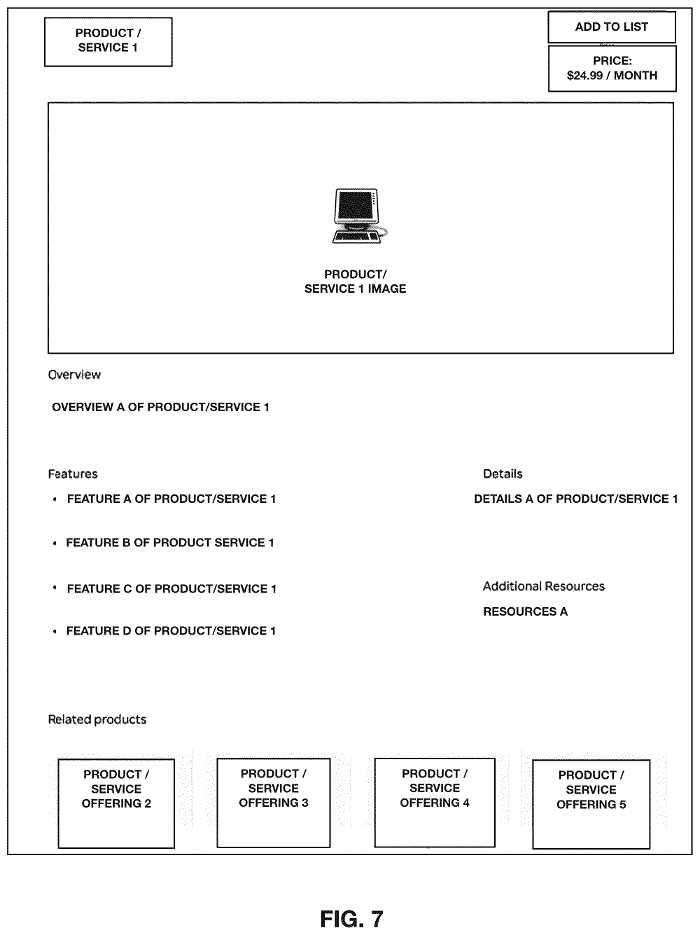

FIG. 7 illustrates another non-limiting exemplary embodiment of a GUI portal of details for a product/service of the network services marketplace platform. From here, the user may review the details of network product/service which he has selected (e.g., from the GUI portal of FIG. 6), and may add the network product/service into a purchase list/product interest list.

FIG. 8A illustrates another non-limiting exemplary embodiment of a GUI portal of a product/service purchasing page of the network services marketplace platform, further illustrating a product interest list, including details of a specific selected product/service, such as the number of users, size of data storage, and price. From here, the user may checkout and submit his/her order or purchase request to the network services marketplace platform of the disclosure described herein. Further, the user may also choose to specify his requirement on the selected product/service. Furthermore, the user may also choose to continue browsing for other network products/services.

FIG. 8B illustrates another non-limiting exemplary embodiment of a GUI portal of a product/service customization page of the network services marketplace platform, further illustrating an option for the user to optionally configure or customize his/her product/service selection.

FIG. 9 illustrates one non-limiting exemplary embodiment of a GUI portal of a back-office dashboard page of the network services marketplace platform. The GUI portal of the back-office dashboard page may include status of service(s) associated with the user, such as a request for quote (RFQ) traffic and product interest of the service(s). Here, the back-office dashboard can also include GUI menu elements for selecting additional sub-pages or sub-portals having information pertaining to a Product Catalog (including additional sub-pages or sub-portals for Catalogs, Categories, Products, and Specifications), Leads, Orders, and Customers.

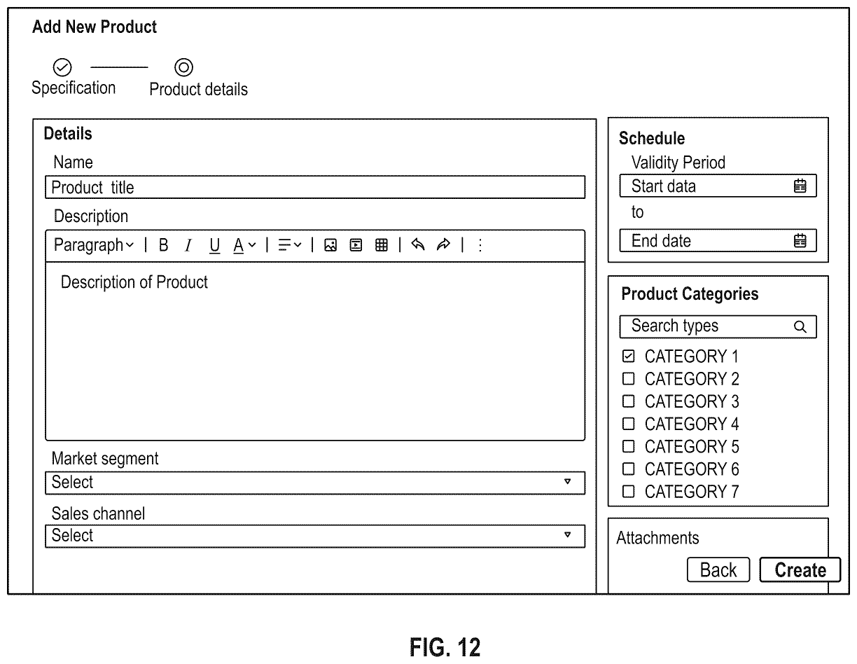

FIG. 10 illustrates one non-limiting exemplary embodiment of a GUI portal for a Products sub-page of the back-office dashboard, including viewing each network service/product associated with the user (e.g., seller, vendor, service provider, etc.). The GUI portal of the products sub-page may include a list of products, wherein the list further includes a status of each of the products, a category of each of the products, and any other suitable information of the products/services. From here, the user may also create new products/services (e.g., by triggering a button “New product” or any other suitable options for triggering the creation of new products/services) and further add various characteristics, pricing, and options to each product and product specification, such as shown in FIGS. 11-12 for exemplary purposes.

FIG. 11 illustrates a GUI portal for defining a specification for a new product. As shown in FIG. 11, a user may select an existing (i.e., previously defined and stored) specification or create a new specification. For example, if the user selects “Use existing specification,” a list of existing specifications may subsequently be presented, from which a user may select a specification to use. Otherwise, the user may create a new specification by filling out one or more of the fields shown in the exemplary GUI portal of FIG. 11. For example, the user may provide a title or name for the specification, a description of the specification, a product number for the corresponding product to which the specification applies, a validity period for the specification, and a product type (either manually or by searching and selecting from among predefined product types). It is understood that one or more of the fields shown may be mandatory (i.e., must be defined by a user) and one or more may be optional (e.g., a user may not define or set a validity period). Further, one or more additional fields may be included. For example, one or more parameters or characteristics of a product may be defined, such as different selectable parameters that a user (purchaser or customer) may set upon buying the product (e.g., a number of user accounts or licenses, a size of a data storage, etc.), default values for the selectable options, etc. In this case, the parameter or characteristic may be set so as to be defined by a customer (e.g., a customer can manually enter a number of user accounts or size of data storage) or the user may define the selectable options in the specification. The parameters or characteristics may be manually defined or created by a user, or may be predefined or associated with a product type selected by a user (and may then be edited by the user in the specification page).

FIG. 12 illustrates a GUI portal for defining product details for a new product. For example, the product details page may be displayed upon completion of defining the specification for the new product. Via the product details GUI shown in FIG. 12, by way of example, the user may define or set the product title, a description of the product, a market segment, a sales channel, a category for the product (e.g., by selecting one from among plural predefined categories, or by manually creating a new category), a validity period for the product, and attachments (e.g., a product image, product manual, technical specifications document, etc.). A user may also set a price (or various prices corresponding to different customizable options) for the product via the product details page, a location(s) at which the product/service may be provided, etc.

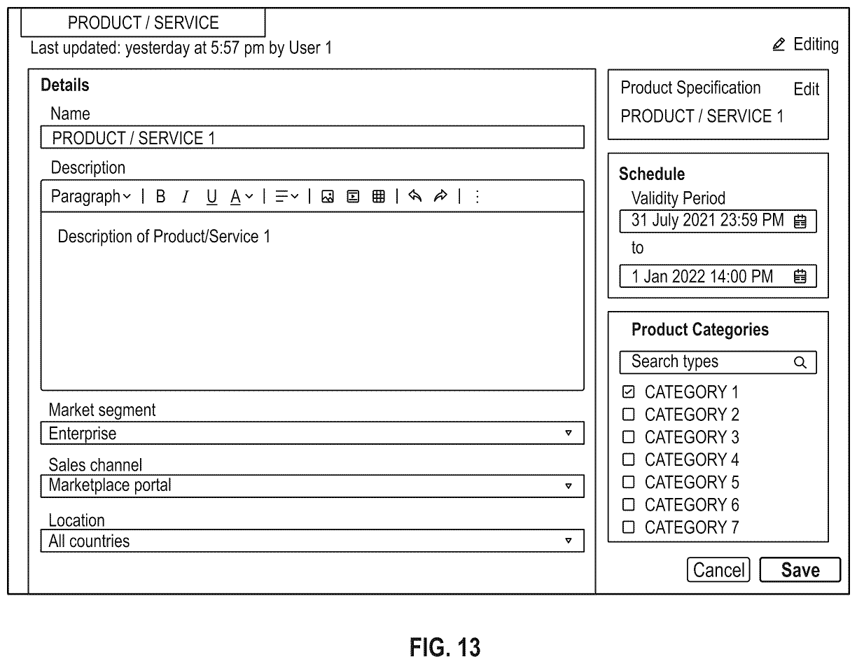

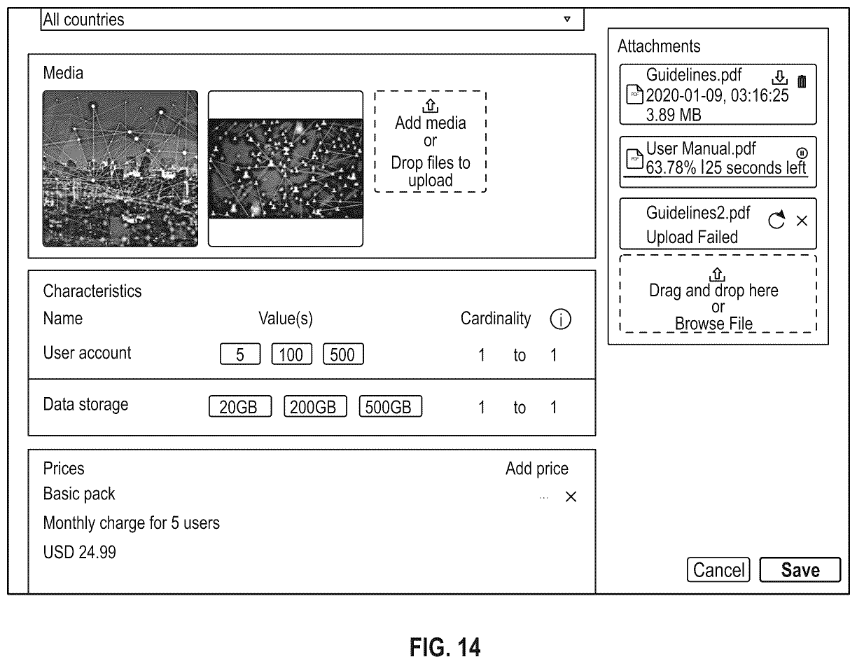

Within the Products sub-page shown in FIG. 10, the user may also be able to select a product/service that is listed therein, in order to edit a product/service, edit the specifications of a product/service, view product/service details, assign a product/service to a product/service category, apply a sales or offering schedule to a product/service, create additional pricing options for a product/service (such as a monthly recurring fee or a one-time fee), including technical information or manuals with the product, and browse and add linked or associated products/services, among others, such as shown in FIGS. 13-14 for exemplary purposes.

FIGS. 13 and 14 illustrate a GUI portal for editing product details of a previously created product/service. As shown in FIGS. 13 and 14, any of the values or information of the product details that can be defined upon creating the product/service may subsequently be edited.

FIG. 15 illustrates one non-limiting exemplary embodiment of a GUI portal for an Orders sub-page of the back-office dashboard, including viewing customer orders and their status, among others. From here, the user may also view a specific order, view and select workflow options for an order (e.g., processing, on hold, completed, cancelled, refunded, and pending payment), edit specific orders (including browsing products/services to add/replace), and further select or define prices for an order.

FIG. 16 illustrates another non-limiting exemplary embodiment of the Orders or Products sub-page of the back-office dashboard. From here, the user can select and customize prices and pricing options for a particular order or a particular product/service.

FIG. 17A illustrates another non-limiting exemplary embodiment of the Orders or Products sub-page of the back-office dashboard. From here, the user can apply a price event (such as a price reduction) to a particular order or product/service, such as shown in FIG. 17B. As shown in FIG. 17B, the user may add a name for the price event, and include the price, frequency, interval, and duration for the price event.

It is understood that the specific order or hierarchy of blocks in the processes/flowcharts disclosed herein is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

What is claimed is:

1. A method of trading telecommunications related services on a centralized marketplace network, the method comprising:
presenting a first telecommunications related service to a first user, wherein the first telecommunications related service is based on a configuration profile defined by a second user;
receiving a selection for the first telecommunications related service by the first user; and
receiving a purchase order request from the first user with respect to the selected first telecommunications related service.

2. The method of claim 1, further comprising:
receiving input from the first user with respect to customizing or configuring the first telecommunications related service;
receiving input from the first user to add the customized or configured first telecommunications related service to the purchase order request; and
applying a price modification or reduction to the first telecommunications related service or the purchase order request.

3. The method of claim 2, wherein the configuration profile further comprises the price modification or reduction, wherein the price modification or reduction is associated with the first user.

4. The method of claim 1, further comprising:
receiving one or more identifying information with respect to the first user, wherein the identifying information is comprised of one or more: name, locations, company, job role, and contact time.

5. The method of claim 1, further comprising:
receiving a request from the second user to access a dashboard portal.

6. The method of claim 5, wherein the dashboard portal comprises at least one of: a product or service catalog portal, a customer lead or prospect information portal, a customer purchase history portal, or a product or service ordering portal.

7. The method of claim 6, further comprising:
receiving a request from the second user to create a second telecommunications related product or service within the product or service catalog portal.

8. The method of claim 7, wherein the created second telecommunications related product or service is a software-based network service or a virtual network service.

9. The method of claim 6, further comprising:
receiving a request from the second user to create one or more customer leads or prospects within the customer lead or prospect information portal.

10. The method of claim 6, further comprising:
receiving a request from the second user to create one or more promotional campaigns with respect to the second telecommunications related product or service based on the first user or a third user's purchase history from the customer purchase history portal or the product or service ordering portal.

11. The method of claim 1, wherein the first user is comprised of an end user and the second user is comprised of a network service provider.

12. An apparatus for trading telecommunications related services on a centralized marketplace network, comprising:
a memory storage storing computer-executable instructions; and
a processor communicatively coupled to the memory storage, wherein the processor is configured to execute the computer-executable instructions and cause the apparatus to:
present, via a central server, a first telecommunications related service to a first user, wherein the first telecommunications related service is based on a configuration profile defined by a second user;
receive, from the first user, a selection for the first telecommunications related service; and
receive, from the first user, a purchase order request with respect to the selected first telecommunications related service.

13. The apparatus of claim 12, wherein the computer-executable instructions, when executed by the processor, further cause the apparatus to:
receive input from the first user with respect to customizing or configuring the first telecommunications related service;
receive input from the first user to add the customized or configured first telecommunications related service to the purchase order request; and
apply a price modification or reduction to the first telecommunications related service or the purchase order request.

14. The apparatus of claim 12, wherein the configuration profile further comprises the price modification or reduction, wherein the price modification or reduction is associated with the first user.

15. The apparatus of claim 12, wherein the computer-executable instructions, when executed by the processor, further cause the apparatus to:
receive one or more identifying information with respect to the first user, wherein the identifying information is comprised of one or more: name, locations, company, job role, and contact time.

16. The apparatus of claim 12, wherein the computer-executable instructions, when executed by the processor, further cause the apparatus to:
receive, from the second user, a request to access a dashboard portal.

17. The apparatus of claim 16, wherein the dashboard portal comprises at least one of: a product or service catalog portal, a customer lead or prospect information portal, a customer purchase history portal, or a product or service ordering portal.

18. The apparatus of claim 17, wherein the computer-executable instructions, when executed by the processor, further cause the apparatus to:
receive, from the second user, a request to create a second telecommunications related products or services within the product or service catalog portal.

19. The apparatus of claim 12, wherein the first user is comprised of an end user and the second user is comprised of a network service provider.

20. A non-transitory computer-readable medium comprising computer-executable instructions for trading telecommunications related services on a centralized marketplace network by an apparatus, wherein the computer-executable instructions, when executed by at least one processor of the apparatus, cause the apparatus to:
present a first telecommunications related service to a first user, wherein the first telecommunications related service is based on a configuration profile defined by a second user;
receive a selection for the first telecommunications related service by the first user; and
receive a purchase order request from the first user with respect to the selected first telecommunications related service.
